(19) United States
(12) Patent Application Publication
(10) Pub. No.: US 2026/0051304 A1
(43) Pub. Date: Feb. 19, 2026

(54) Method for producing a cymbal, in particular a ride cymbal, with a shaped sound profile, in particular with a particularly narrow fre-quency range and short decay time, cymbal with a shaped sound pro-file and system

(71) Applicant: Roland Meinl Musikinstrumente GmbH & Co. KG, Gutenstetten (DE)

(72) Inventor: Benjamin GREB, Hamburg (DE)

(21) Appl. No.: 19/300,852

(22) Filed: Aug. 15, 2025

(30) Foreign Application Priority Data
Aug. 16, 2024 (DE) 10 2024 207 821.2

(51) Int. Cl. G10D 13/24; G10D 13/063

(52) U.S. Cl. CPC G10D 13/24; G10D 13/063

(57) ABSTRACT

A method for producing a cymbal, in particular a ride cymbal, with a shaped sound profile, in particular with a particularly narrow frequency range and short decay time, comprising the steps: providing a blank made of sheet metal, reshaping the blank to produce a base body with a cymbal shape, automated removal of at least an edge piece from the base body to produce at least one sound-shaping cut-out in the base body, wherein the sound-shaping cut-out is open towards an edge of the base body and, wherein the sound-shaping cut-out is produced to precisely shape the sound profile according to a predetermined sound influence geometry. Furthermore a cymbal with a shaped sound profile and a system having such a cymbal.

The present patent application claims the priority of the German patent application DE 10 2024 207 821.2, the contents of which are incorporated herein by reference.

The invention relates to a method for producing a cymbal, in particular a ride cymbal, with a shaped sound profile. The invention further relates to a cymbal with a shaped sound profile. The invention also relates to a system having such a cymbal.

Cymbals, in particular ride cymbals, with different sound profiles are known from the prior art. The sound profile is in particular determined by the diameter, wall thickness and material composition of the cymbal, as well as by the shape of the curvature and the extent of local material hardening, which is conventionally produced by means of hammering. There are limits to how much it is possible to influence the sound profile. Certain sound differences can only be achieved at great cost.

Cymbals with special sound influence geometries are disclosed in US 2022/0199055 A1 and US D 532,439 S. A cymbal with a special material composition is disclosed in US 2016/0189693 A1.

One object of the invention is an improved method for producing a cymbal, in particular a ride cymbal, which in particular guarantees particularly comprehensive and precise influence on the sound profile in an efficient manner.

This object is achieved by a method having the features of claim 1. It has been recognised that in a method for producing a cymbal, in particular a ride cymbal, particularly comprehensive, efficient and precise shaping of the sound profile is enabled if at least an edge piece is removed in an automated manner from a base body with a cymbal shape in order to produce at least one sound-shaping cut-out in the base body, which is open towards an edge of the base body and which is produced to precisely shape the sound profile according to a predetermined sound-shaping geometry. The sound profile can be particularly comprehensively influenced by means of the at least one sound-shaping cut-out, in particular the sound duration can be reduced, whereby particularly quick sound sequences can be produced, the sound spectrum can be shifted to higher frequencies and/or a narrower frequency distribution, i.e. a clearer sound, can be achieved. This is guaranteed by means of the described method to a degree that was previously impossible or only achievable at great cost. The method guarantees in particular a high degree of repeatability and efficiency, in particular in series production.

A blank made of sheet metal is first preferably provided. The blank can be produced in a casting method and/or a rolling method.

In order to produce the blank and/or the cymbal shape, the sheet metal can be trimmed, preferably in such a manner that it has a substantially oval shape, in particular a circular shape.

The sheet metal is preferably made of a metallic material, in particular with a predominant copper content and/or of bronze, in particular a B8 bronze alloy or a B20 bronze alloy.

The blank can be reshaped to produce the base body. The blank can be reshaped in an automated manner and/or manually, in particular through at least one of the steps: pressing and/or deep drawing and/or hammering the blank. The reshaping can at least partially take place at a temperature below 100° C. in order to achieve work hardening.

When the blank is reshaped, a bell or dome of the cymbal is preferably produced.

Soft annealing of the blank and/or cymbal preferably takes place before and/or after reshaping.

The automated removal of the at least an edge piece from the base body can be carried out at least partially, preferably completely, by machine, in particular in a fully automated manner, for example by cutting, in particular laser cutting and/or plasma cutting and/or water jet cutting, and/or punching and/or grinding.

An automated method step, in particular automated removal, is preferably understood to mean that at least one tool for carrying out the method step, in particular for machining the base body, in particular a cutting tool, is guided and/or displaced mechanically, in particular by a motor, in particular relative to the base body, in particular in accordance with the specified sound influence geometry. In other words, when the automated method step is carried out, a tool is preferably mechanically displaced relative to the workpiece to be machined, in particular along a machining path corresponding to the sound influence geometry. The tool can have a tool base body and a workpiece contact means, in particular a cutting means, wherein the cutting means can be driven relative to the tool base body mechanically, in particular by a motor. For example, a cutting means of a separating and/or grinding tool, in particular a rotary cutter, can be driven in rotation by a motor relative to the tool base body.

The sound-shaping geometry can be provided on a machining tool in the form of machine-readable, in particular digital, data.

Before and/or after reshaping, a hole, in particular for attaching the cymbal to a cymbal stand, can be made in particular through a cymbal centre, in particular cut, in particular by laser cutting, and/or drilled and/or punched. The hole can be produced during reshaping.

In principle, the at least one sound-shaping cut-out can be produced during reshaping, for example by punching, in particular in a single reshapingpunching step. The at least one sound-shaping cut-out is preferably removed after reshaping, in particular after pressing and/or after hammering for producing the cymbal shape.

The base body or the cymbal are preferably oval and/or circular in shape in a plan view.

In the region of the at least one sound-shaping cut-out, the outer counter of the cymbal preferably deviates from a regular shape, in particular from the oval shape, in particular the circular shape. The sound-shaping cut-out can therefore also be referred to as an edge interruption.

The at least one sound-shaping cut-out forms a section of an outer contour of the cymbal. In the region of the at least one sound-shaping cut-out, the cymbal can have a gap in a plan view in relation to a smallest convex hull. At the very least, this gap is understood as the sound-shaping cut-out, in particular if the regular shape cannot be determined, in particular if it deviates greatly from a circular shape or an oval shape.

The at least one sound-shaping cut-out can have an area of at least 5 cm², in particular at least 10 cm², in particular at least 15 cm², in particular at least 20 cm², in particular at least 25 cm², in particular at least 30 cm², in particular at least 40 cm², and/or at most 100 cm², in particular at most 60 cm² in a plan view, in particular relative to the regular shape of the outer contour. At least one, in particular at least two, in particular at least three, in particular at least five, and/or at most 10, in particular at most six, sound-shaping cut-outs are preferably provided.

The at least one sound-shaping cut-out is preferably delimited by the region of the outer contour of the cymbal which has the regular shape and/or forms the smallest convex hull, in particular in a plan view.

According to one aspect, exactly one sound-shaping cut-out is produced on the cymbal. Due to the fact that there is only one sound-shaping cut-out, the strength of the cymbal can be largely retained. This allows the sound-shaping cut-out to be particularly large, which means that the sound profile can be shaped particularly comprehensively. In addition, the sound-shaping cut-out can be arranged in a region that does not disturb the player when the cymbal is played.

In addition to the at least an edge-side sound-shaping cut-out, the cymbal can have at least one, in particular a plurality of, inner cut-outs, which are completely surrounded by the base body, in particular in a plan view.

The cymbal is preferably concave in shape at least in sections in a plan view in the region of the sound-shaping cut-out. In the region of the concave shape, the outer contour of the cymbal can be offset inwards or towards the cymbal centre in a plan view relative to a smallest convex hull. The concave region can be delimited by the points where a curvature of the outer contour of the cymbal undergoes a sign change.

The cymbal is preferably kink-free in the region of the sound-shaping cut-out, in particular in the region of the concave shape, in particular with a minimum radius or a smallest cut-out radius of at least 10 mm, in particular at least 20 mm, in particular at least 40 mm, in particular at least 80 mm, and/or at most 400 mm, in particular at most 300 mm, in particular at most 200 mm. The fact that the minimum radius is large in the region of the concave section prevents notch stresses which could result in premature breakage of the cymbal.

According to one aspect, the at least one sound-shaping cut-out is substantially lentil-shaped. A contour of the at least one sound-shaping cut-out can be elliptical and/or circular at least in sections.

The cymbal is preferably a cymbal played on its own, in particular a ride cymbal or a crash cymbal or a China cymbal, in particular not a cymbal played in pairs, such as a hi-hat cymbal. Alternatively, the cymbal can be a hi-hat cymbal, in particular the upper and/or lower hi-hat cymbal.

According to a further aspect, the automated removal of the at least an edge piece from the base body can be carried out by means of a multi-axis machine, in particular an articulated robot. A tool with a geometrically defined or undefined cutting edge can be used for removal, such as a punching tool and/or a cutting tool and/or a grinding tool, in particular a cut-off grinding tool.

The at least one sound-shaping cut-out preferably extends in a plan view over an angle, in particular around the cymbal centre, of at least 15°, in particular at least 20°, in particular at least 25°, in particular at least 30°, in particular at least 35°, in particular at least 40°, in particular at least 45°, and/or at most 120°, in particular at most 100°, in particular at most 90°, in particular at most 60°. The at least one sound-shaping cut-out, in particular all sound-shaping cut-outs combined, can form at least 10%, in particular at least 20%, in particular at least 30%, and/or at most 60%, in particular at most 40% of the outer contour of the cymbal in a plan view of the cymbal. This ensures that the sound profile can be particularly comprehensively influenced.

A ratio of a maximum radial extension of the at least one sound-shaping cut-out to a maximum radial dimension of the cymbal is preferably at least 1:10, in particular at least 1.5:10, in particular at least 2:10, in particular at least 2.5:10, in particular at least 3:10 and/or at most 8:10, in particular at most 6:10, in particular at most 5:10. This ensures that the sound profile can be comprehensively influenced without significantly impairing the stability of the cymbal.

A maximum radial extension of the at least one sound-shaping cut-out is preferably in a range of 2 cm to 40 cm, in particular 4 cm to 30 cm, in particular 6 cm to 20 cm and in particular 8 cm to 16 cm.

Radial sizes are preferably determined to the cymbal centre, in particular in a plan view of the cymbal.

The cymbal preferably has a diameter of at least 14″ (inches), in particular at least 16″, in particular at least 18″, in particular at least 20″, in particular at least 22″, and/or at most 28″, in particular at most 24″. It is possible to particularly comprehensively influence the sound by means of the at least one sound-shaping cut-out with correspondingly large cymbals.

The cymbal preferably has a weight in a range of 1 kg to 10 kg, in particular 1.5 kg to 6 kg, in particular 2 kg to 5 kg, in particular 2.5 kg to 4 kg. Correspondingly heavy cymbals can be adjusted particularly comprehensively and efficiently in terms of their sound profile with the at least one sound-shaping cut-out.

According to one aspect, the cymbal has a wall thickness of at least 0.5 mm, in particular at least 0.8 mm, in particular at least 1 mm, in particular at least 1.5 mm, and/or at most 3 mm, in particular at most 2.5 mm, in particular at most 2 mm, in particular at most 1.8 mm. This wall thickness is preferably determined as the maximum wall thickness at the edge of the at least one sound-shaping cut-out and/or as the maximum wall thickness of the cymbal, in particular at half the radial dimension of the cymbal. At such wall thicknesses, the sound profile of the cymbal can be particularly comprehensively shaped, wherein the strength of the cymbal is sufficiently maintained.

The base body is preferably hammered and/or material is turned off before the automated removal. The shape of the at least one sound-shaping cut-out can be adapted to the sound characteristics of the largely completed cymbal.

The sound profile of the base body is preferably recorded, in particular by means of acoustic measurement. The recorded sound profile can be used to determine the sound influence geometry, in particular for producing one or more cymbals. The sound profile can be recorded before removing the at least one sound-shaping cut-out and/or after removing part the at least one sound-shaping cut-out and/or some of the plurality of sound-shaping cut-outs. In particular, the sound influence geometry of an already partially produced sound-shaping cut-out can be reworked using the recorded sound profile. The sound influence geometry can thus be individually adapted to the respective sound profile of the base body or cymbal, in particular each individual cymbal or once for a batch of a plurality of cymbals, in particular before removal. This allows manufacturing tolerances to be taken into account. The sound profile can thus be shaped particularly precisely.

Another object of the invention involves producing an improved cymbal, in particular a ride cymbal, which can in particular be produced particularly efficiently and has a precisely adjusted sound profile.

This object is achieved by a cymbal, in particular a ride cymbal, with a shaped sound profile, having a base body with a cymbal shape and at least one sound-shaping cut-out in the base body, which is open towards an edge of the base body and which is produced to precisely shape the sound profile according to a predetermined sound influence geometry. The cymbal is preferably produced according to a method in accordance with the preceding description. The cymbal is preferably further developed with at least one of the features described above in connection with the method. In particular, the cymbal can have at least one tangible feature described above in connection with the method. The advantages of the cymbal correspond to the advantages of the method. The sound profile of the cymbal can be particularly comprehensively and precisely adjusted thanks to the at least one sound-shaping cut-out. In particular, the sound spectrum can be shifted to higher tones, the decay time can be reduced and/or the frequency range can be narrowed. The sound of the cymbal can thus be adjusted to be particularly short, intense and clear. Such cymbals open up new areas of application and are particularly suitable for fast playing patterns.

Another object of the invention involves creating an improved system, in particular a drum kit, which can in particular be produced in a particularly cost-effective manner and is high quality.

This object is achieved by a system, in particular a drum kit, having at least one cymbal according to the preceding description and at least one other percussion instrument, in particular at least one membranaphone and/or idiophone. The system is preferably further developed with at least one of the features described above in connection with the method or cymbal. The advantages of the system correspond to the advantages of the method or cymbal described above.

The cymbal is preferably arranged on a cymbal stand and is preferably used on its own, in particular not in pairs.

Alternatively, the cymbal can be a hi-hat cymbal, which is attached to a hi-hat machine. The cymbal can form the upper and/or lower hi-hat cymbal. It is also advantageous that the at least one sound-shaping cut-out allows air to escape between the hi-hat cymbals, which can prevent a so-called air lock.

Further features, advantages and details of the invention result from the following description of a plurality of exemplary embodiments based on the figures. In the drawing:

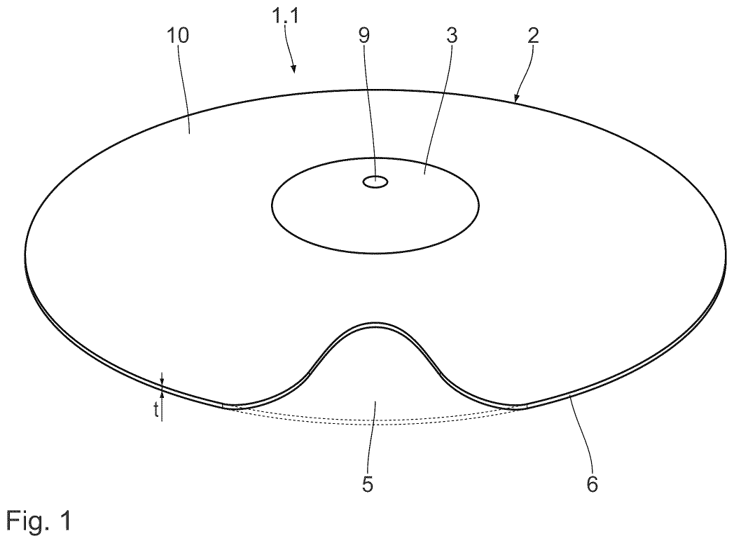

FIG. 1 shows a perspective view of a cymbal according to a first embodiment with a base body and a parabolic sound-shaping cut-out in the base body,

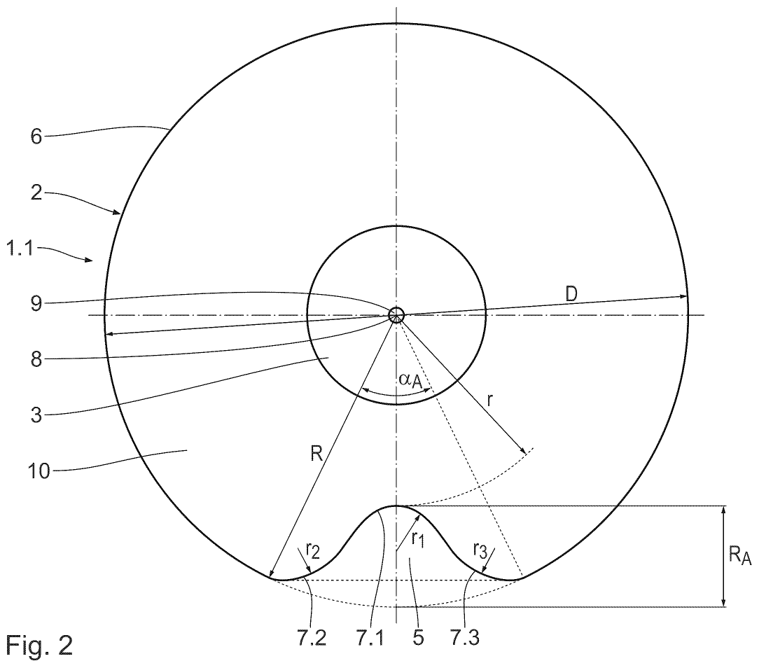

FIG. 2 shows a top view of the cymbal shown in FIG. 1,

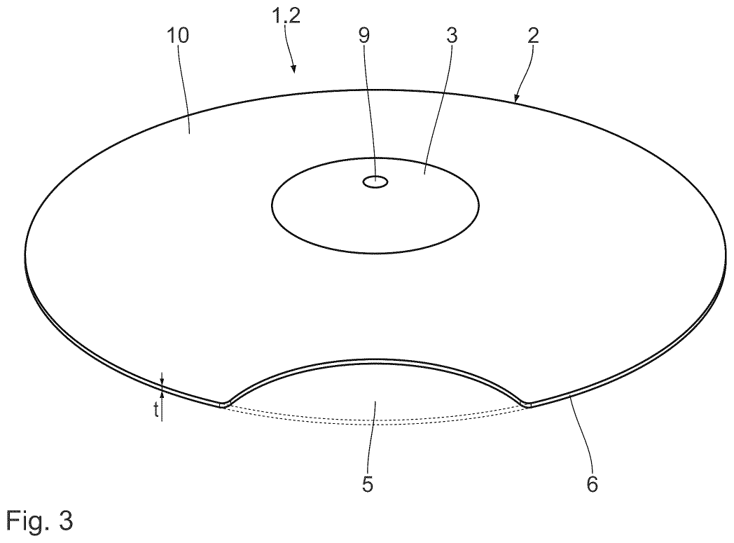

FIG. 3 shows a perspective view of a cymbal according to another embodiment, wherein the sound-shaping cut-out is arcuate,

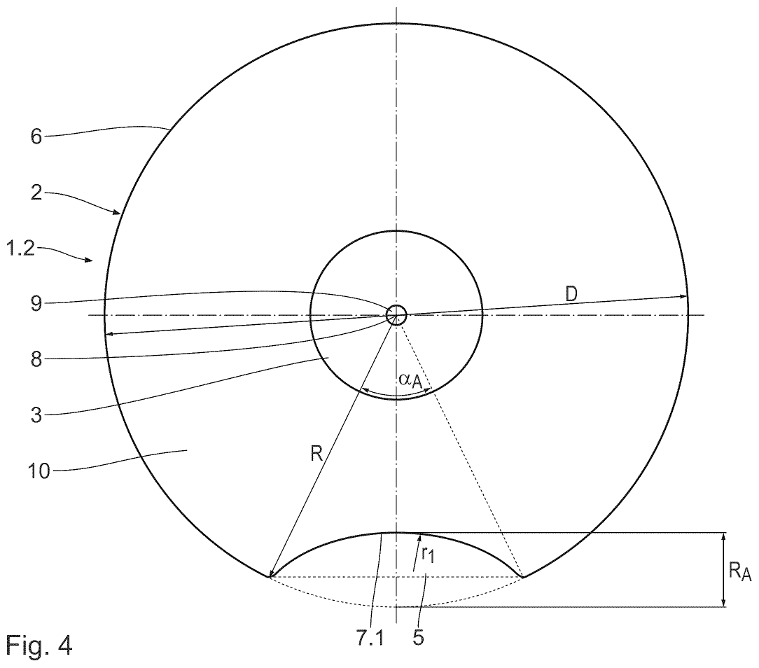

FIG. 4 shows a top view of the cymbal shown in FIG. 3, or

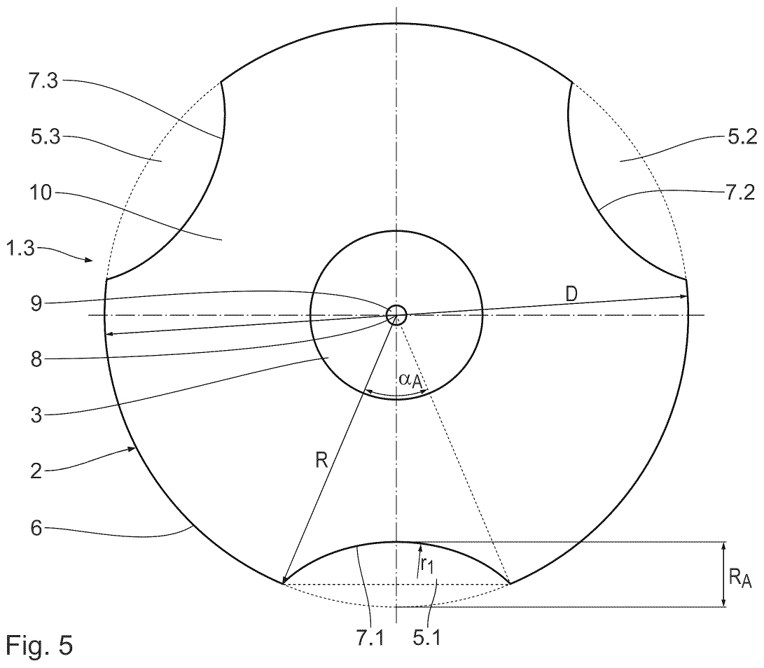

FIG. 5 shows a top view of a cymbal according to another embodiment, wherein three sound-shaping cut-outs are provided in the base body.

With reference to FIGS. 1 and 2, a first embodiment of a cymbal 1.1 is described with a shaped sound profile, in particular with a particularly narrow frequency range and a short decay time. The cymbal 1.1 has a curved base body 2 with a central bell or dome 3. A sound-shaping cut-out 5 is formed in the base body 2. The sound-shaping cut-out 5 is open towards an edge of the base body 2.

The base body 2 has a single edge-side sound-shaping cut-out 5. Alternatively, the base body 2 can have a plurality of the edge-side sound-shaping cut-outs 5 and/or one or more recesses arranged within the base body 2 and completely surrounded by the base body 2 in a plan view.

The base body 2 is preferably substantially circular in a plan view, in particular apart from the at least one sound-shaping cut-out 5.

The cymbal 1.1 is a ride cymbal. It preferably has a diameter D in the range of 18″ to 24″, in particular 18″. A wall thickness t can be in the range of 1 mm to 2 mm, in particular 1.2 mm to 1.7 mm, in particular 1.5 mm.

A radial dimension R of the cymbal 1.1 corresponds in general to half the diameter D.

An outer contour 6 of the cymbal 1.1 deviates from a regular shape, in particular the circular shape, in the region of the sound-shaping cut-out 5 formed as an edge-side recess.

The sound-shaping cut-out 5 has a special sound influence geometry. This is composed of a parabolic central region 7.1 and two adjoining arcuate regions 7.2, 7.3. The radii r₂, r₃ of the circular regions 7.2, 7.3 are 5 cm in a plan view.

The cymbal 1.1 is concave in shape in the, in particular parabolic, central region 7.1 of the sound-shaping cut-out 5. In the concave region, the cymbal 1.1 has a smallest cut-out radius r₁ of at least 20 mm, in particular at least 40 mm, in particular at least 60 mm, in particular about 80 mm.

A maximum radial extension R_{A} of the sound-shaping cut-out 5 in relation to a cymbal centre 8 is 80 mm. The smallest radius r of the cymbal 1.1 in the region of the sound-shaping cut-out 5, in relation to the cymbal centre 8, is 148.6 mm.

In relation to the cymbal centre 8, the sound-shaping cut-out 5 extends over an angle α_{A} in a range of 20° to 90°, in particular 25° to 60°, in particular around 45°.

The cymbal 1.1 preferably has a weight of 3 kg.

The cymbal 1.1 is preferably a component of a system (not shown), in particular a drum kit, having at least one other percussion instrument, in particular a membranophone, in particular a base drum and/or a snare drum and/or another idiophone, in particular a hi-hat and/or a crash cymbal. The cymbal 1.1 is preferably arranged in the system on its own, preferably in particular not in pairs, in particular attached to a cymbal stand which is in particular rigid.

The cymbal 1.1 is preferably produced according to the method described below:
first of all, a blank made of sheet metal, preferably a bronze alloy, in particular a B20 bronze alloy or a B8 bronze alloy is provided. The production of the blank preferably comprises at least one of the steps: pouring metal into a casting mould, in particular a disc mould, and/or rolling, in particular cold rolling, the sheet metal and/or hammering the sheet metal.

A hole 9 for attaching and/or centring the blank to/on a machining tool and/or for attaching the cymbal 1.1 to the cymbal stand is preferably made in the base body 2, in particular in the region of the cymbal centre 8.

The blank is reshaped to produce the base body 2 with a cymbal shape. Reshaping preferably comprises at least one of the steps: pressing the sheet metal into a curved shape, in particular to produce the bell 3, and/or hammering the sheet metal, in particular for local shaping and/or hardening.

In order to produce the sound-shaping cut-out 5, an edge piece is cut out of the main body 2. It is preferably removed in an automated manner according to a predetermined sound influence geometry. The sound influence geometry can be designed as described above.

The sound-shaping geometry can be standardised or individually determined. The sound profile of the base body 2 can be recorded, in particular my means of acoustic measurement, for individually determining the sound influence geometry. The recorded sound profile can be used to determine the sound influence geometry, in particular adapted to the individual sound characteristics of the base body 2.

Removal is preferably carried out by means of a multi-axis machine, in particular having at least two, in particular at least three, in particular at least four, machine axes. Even more preferably, removal is carried out by means of a multi-joint robot.

After removal, edge processing, particularly deburring, can take place.

The base body 2 is preferably hammered and/or material is turned off at least in regions, in particular completely, in particular before the automated removal, in particular to set a predetermined wall thickness t.

The cymbal 1.1 or the system formed therewith functions as follows:

The cymbal 1.1 is mounted on a cymbal stand, in particular by means of the hole 9. The cymbal 1.1 is combined with other percussion instruments to form a drum kit.

The cymbal 1.1 can be played in a known manner by striking the bell 3 or the adjoining collar-shaped or curved region 10.

Thanks to the sound-shaping cut-out 5, the sound profile of the cymbal 1.1 is specially shaped in particular in such a way that the resulting sound has a particularly narrow frequency range and a short decay time. The sound is also higher than that of a cymbal without the at least one sound-shaping cut-out 5.

The geometry of the sound-shaping cut-out 5 is significantly responsible for the resulting sound profile. The sound profile can be defined very flexibly via the geometry of the sound-shaping cut-out 5.

Substantial modifications to the sound profile can be achieved by changing the maximum radial extension R_{A} and/or the angle as of the sound-shaping cut-out 5.

Finer tuning of the sound profile, in particular the frequency range, is possible by modifying the detailed geometry of the sound-shaping cut-out 5. For example, corresponding fine tuning of the sound profile can be achieved by modifying the radii r₂, r₃ and/or the cut-out radius r₁.

The cymbal 1.1 described above forms a musical instrument with a sound profile that has previously been unachievable. The shaping of the sound profile that can be achieved by means of the at least one sound-shaping cut-out 5 provides a high degree of flexibility when creating new cymbal variants with an individual sound profile. A drum kit having one or more such cymbals 1.1 can produce previously unachievable tone sequences. The higher frequency range can expand the overall achievable frequency spectrum. The shorter decay time enables the cymbal 1.1, in particular the drum kit, to be played particularly quickly, with fast playing patterns.

Another embodiment of a cymbal 1.2 is described with reference to FIGS. 3 and 4. In contrast to the previously described embodiment, a sound-shaping cut-out with a different sound-shaping geometry is provided in the base body 2. The sound-shaping cut-out 5 forms an arcuate section 7.1 of the outer contour 6 of the cymbal 1.2. The outer contour 6 has an edge rounding at the edge of the sound-shaping cut-out 5. Alternatively, the outer contour 6 can have a kink at one or at both edges of the sound-shaping cut-out 5. The, in particular smallest, cut-out radius r₁, in particular in the region of its concave shape, is 10 cm.

The cymbal 1.2 is a single cymbal, in particular one not played in pairs, in particular a crash cymbal.

A diameter D of the cymbal 1.2 is preferably 16″.

The angle α_{A} of the sound-shaping cut-out can be 40°.

A single sound-shaping cut-out 5 is preferably provided. In principle a plurality of edge-side sound-shaping cut-outs 5 can also be provided.

A maximum radial extension R_{A} of the sound-shaping cut-out 5 in the plan view, in particular relative to a substantially circular outer contour 6, is 60 mm.

The cymbal 1.2 is produced according to the method described above. The mode of operation corresponds to that of the cymbal 1.1 described above.

Due to the fact that the maximum radial extension R_{A} and the angle da are smaller compared to the previously described embodiment, the influence of the sound-shaping cut-out 5 on the sound profile is smaller. The frequency range is less narrowed and the decay time is reduced to a lesser extent.

Another embodiment of a cymbal 1.2 is described with reference to FIG. 5. Unlike the previously described embodiments, three sound-shaping cut-outs 5.1, 5.2, 5.3 are provided. The sound influence geometry of the respective sound-shaping cut-out 5.1, 5.2, 5.3 corresponds substantially to that of the sound-shaping cut-out 5 of the cymbal 1.2, wherein the outer contour 6 has a kink on the respective edge of the sound-shaping cut-outs 5.1, 5.2, 5.3 Alternatively, roundings, in particular edge roundings, can be provided in the edge regions of the respective sound-shaping cut-outs 5.1, 5.2, 5.3.

The sound-shaping cut-outs 5.1, 5.2, 5.3 are spaced apart from one another by the same angle of 120° relative to the cymbal centre 8. The three sound-shaping cut-outs 5.1, 5.2, 5.3 are arranged in particular point-symmetrically around the cymbal centre 8, in particular around a vertical axis of the cymbal 1.3.

Alternatively, at least two, in particular all of the sound-shaping cut-outs 5.1, 5.2, 5.3 have different sound-shaping geometries and/or different angular distances relative to one another.

At least two, in particular at least three, in particular more than three, sound-shaping cut-outs 5.1, 5.2, 5.3 can be provided.

The cymbal 1.3 can be designed as a ride or crash or China cymbal.

The production and mode of operation of the cymbal 1.3 correspond to those according to the previously described embodiments.

The plurality of sound-shaping cut-outs 5.1, 5.2, 5.3 increases the ability to influence the sound profile. As a result, a particularly strongly influenced, in particular narrow, frequency range and a short decay time can be achieved. A system designed with such a cymbal 1.3 is particularly suitable for producing quick sound sequences and produces the desired sound particularly precisely.

1. Method for producing a cymbal, in particular a ride cymbal, with a shaped sound profile, in particular with a particularly narrow frequency range and short decay time, comprising the steps
1.1 providing a blank made of sheet metal,
1.2 reshaping the blank to produce a base body with a cymbal shape, and
1.3 automated removal of at least an edge piece from the base body to produce exactly one sound-shaping cut-out in the base body,
1.3.1 wherein the sound-shaping cut-out is open towards an edge of the base body,
1.3.2 wherein the sound-shaping cut-out is produced to precisely shape the sound profile according to a predetermined sound influence geometry,
1.3.3 wherein the cymbal is concave in shape at least in sections in a plan view in the region of the sound-shaping cut-out,
1.3.4 wherein the cymbal is kink-free in the region of the concave shape, with a smallest cut-out radius r₁ of at least 10 mm, and
1.3.5 wherein the sound-shaping cut-out extends in a plan view over an angle as around the cymbal centre of at least 15° and at most 120°.

2. Method according to claim 1, characterised in that the smallest cut-out radius r₁ is at least 40 mm, in particular at least 80 mm.

3. Method according to claim 1, characterised in that the cymbal is a single cymbal, in particular one not to be played in pairs, in particular a ride cymbal or a crash cymbal or a China cymbal.

4. Method according to claim 1, characterised in that the automated removal is carried out by means of a multi-axis machine, in particular by means of an articulated robot.

5. Method according to claim 1, characterised in that the sound-shaping cut-out extends in a plan view over an angle da around the cymbal centre of at least 25°, in particular at least 30°.

6. Method according to claim 1, characterised in that a ratio of a radial extension R_{A} of the sound-shaping cut-out to a radial dimension R of the cymbal is at least 1:10, in particular at least 1.5:10.

7. Method according to claim 1, characterised in that the cymbal has a diameter D of at least 35 cm, in particular at least 40 cm.

8. Method according to claim 1, characterised in that the cymbal has a weight in a range of 1 kg to 6 kg, in particular of 1.5 kg to 5 kg.

9. Method according to claim 1, characterised in that the cymbal has a wall thickness t of at least 1 mm.

10. Method according to claim 1, characterised in that the base body is hammered and/or material is turned off before the automated removal.

11. Method according to claim 1, characterised by detecting the sound profile of the base body and determining the sound influence geometry of the at least one sound-shaping cut-out based on the detected sound profile.

12. Cymbal, in particular a ride cymbal, with a shaped sound profile, in particular with a particularly narrow frequency range and short decay time, in particular produced in accordance with a method according to one of the preceding claims, having
12.1 a base body with a cymbal shape, and
12.2 at least one sound-shaping cut-out in the base body,
12.2.1 wherein the sound-shaping cut-out is open towards an edge of the base body and
12.2.2 wherein the sound-shaping cut-out is produced to precisely shape the sound profile according to a predetermined sound influence geometry,
12.2.3 wherein the outer contour of the cymbal deviates from a circular shape in the region of the sound-shaping cut-out,
12.2.4 wherein the sound-shaping cut-out extends in a plan view over an angle (aA) around the cymbal centre of at least 15° and at most 120°,
12.2.5 wherein the sound-shaping cut-out is substantially lentil-shaped, and
12.2.6 wherein a maximum of six of the sound-shaping cut-outs are provided.

13. System, in particular drum kit, having
13.1 at least one cymbal according to claim 12, and
13.2 at least one other percussion instrument.
